(19) United States
(12) Patent Application Publication
(10) Pub. No.: US 2009/0006552 A1
(43) Pub. Date: Jan. 1, 2009

(54) SYSTEM AND METHOD FOR PROVIDING A MULTILAYERED MESSAGE

(76) Inventors: GOUTHAM THOLPADI, Bangalore (IN); Manjunath Gopadi, Bangalore (IN)

Correspondence Address: SAP AG, 3410 HILLVIEW AVENUE, PALO ALTO, CA, 94304, US

(21) Appl. No.: 11/768,991

(22) Filed: Jun. 27, 2007

(51) Int. Cl. G06F 15/16

(52) U.S. Cl. 709/205

(57) ABSTRACT

Embodiments of the invention are generally directed to systems and methods for providing a multilayered message. These layers include a first layer and a second layer in the body of the message. A sender includes the first content in the first layer of the message, and the second content in the second layer of the multilayered message. The sender dispatches the multilayer message to a message server. The message server processes this multilayered message and distributes it to the target recipient. Each recipient sees a modified version of the multilayered message, based on the metadata associated with the message and its layers. In one embodiment, a first recipient sees only the first layer of the multilayered message, while a second recipient sees both the first as well as the second layer of the multilayered message.

### FIELD OF THE INVENTION

The invention relates generally to system and method for providing multilayered messages, more particularly to system and method for accessing multilayered messages.

### BACKGROUND OF THE INVENTION

A message system such as an electronic mail (email) system includes a graphical user interface for allowing a user to compose and send email messages to other individuals. The individuals are identified by the corresponding email addresses and the groups of the individuals are identified by an alias or distribution list. An alias or distribution list identifies a group of individuals who are frequently contacted by the sender in order to facilitate identification and reduce the burden of repeatedly entering the individual email addresses. A sender can address a single message to many recipients by separating the email addresses of the recipients or one or more aliases identifying groups of individuals with a semicolon or comma or a space in a header of the graphical user interface of an email editor.

The email editor is used for composing an email. The graphical user interface of the email editor has a header for listing of the recipients and a body for allowing composing of the email message. On selecting a “Send” button, the email is transmitted. On sending of the email, each recipient whose email address is provided in the email header and every individual associated with the one or more aliases provided in the email header will receive the email message. A conventional email editor, such as Microsoft Outlook® and IBM Lotus Notes® does not provide the capability to transmit a part of the email message to the desired recipient. Further, the conventional email editors do not provide the capability to transmit an email message to individuals associated with one alias provided in the header and transmit a portion of the email message to individuals associated with one or more other aliases provided in the header. The conventional email editor is used to send the complete message to the target recipients copied on the email header under “To”, “Cc” (courtesy copy) or “Bcc” (blind courtesy copy). For an email sent with a recipient under “Bcc”, the complete mailing list is not meant to be visible to the other recipient. Currently it is not possible for the sender to send only a part of a message to some recipients in “Bcc” without the knowledge of the other recipients. Therefore there is a need for a messaging system that allows a multilayered message where different layers of messages are meant for different target recipients. There is a further need for a multilayered messaging systems where different layers have different visibilities for different recipients.

### SUMMARY OF THE INVENTION

Embodiments of the invention are generally directed to systems and methods for providing a multilayered message. These layers of the multilayered message include a first layer and a second layer in the body of the message. A sender includes the first content in the first layer of the message, and the second content in the second layer of the multilayered message. The sender dispatches the multilayer message to a message server. The message server processes this multilayered message and distributes it to the target recipient. Each recipient sees a modified version of the multilayered message, based on the metadata associated with the message and its layers. In one embodiment, a first recipient sees only the first layer of the multilayered message, while a second recipient sees both the first as well as the second layer of the multilayered message.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a flow diagram illustrating an example method for providing a multilayered message.

FIG. 2 is a flow diagram illustrating an example detailed method for providing a multilayered message.

FIG. 3 is a system block diagram illustrating a message system implemented according to an embodiment of the invention.

FIG. 4 is a screen display of an example graphical user interface illustrating the composition of a multilayered message.

FIG. 5 is a screen display of an example graphical user interface illustrating the composition of a multilayered message.

FIG. 6 is a screen display of an example graphical user interface illustrating displaying a multilayered message.

FIG. 7 is a screen display of an example graphical user interface illustrating the composition of a multilayered message.

FIG. 8 is a screen display of an example graphical user interface displaying a message screen with multiple layers.

### DETAILED DESCRIPTION

Embodiments of the invention are generally directed to systems and methods for providing a multilayered message. These layers of the multilayered message include a first layer and a second layer in the body of the message. A sender includes the first content in the first layer of the message, and the second content in the second layer of the multilayered message. The sender dispatches the multilayer message to a message server. The message server processes the multilayered message and distributes it to the target recipient. Each recipient sees a modified version of the multilayered message, based on the metadata associated with the message and its layers. In one embodiment, a first recipient sees only the first layer of the multilayered message, while a second recipient sees both the first as well as the second layer of the multilayered message.

According to an embodiment of the invention, a layer of a multilayer message is an entity that contains:

(A) A body—which could contain
text
subject
attachments
formatting information
signatures
etc.

(B) Metadata—which could contain
categorization
authorizations
visibility restrictions
target groups
keywords
different kinds of rules
etc.

A layer can be repeated any number of times in a message. Thus, a multilayered message is a collection of layers along with header information such as sender information, recipient lists, etc.

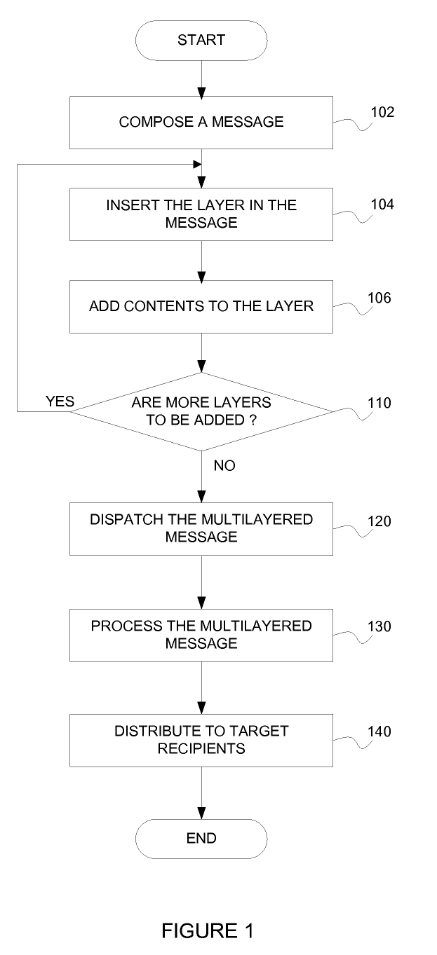

FIG. 1 is a flow diagram illustrating the method for providing a multilayered message, according to an embodiment of the invention. A multilayered message is composed using a multilayered message editor. At 102 the system receives a message composed by a user using a multilayered message editor. At 104 the system inserts a layer in the message and at 106 adds the message contents to the layer of the message. At 110 the system checks whether more layers must to be added to the message. If more layers must be added then flow control returns to 104 and the steps repeat until no more layers are to be added. Thus the message may contain several layers such as a first layer and a second layer. At 120 the system dispatches the multilayered message to the message server and at 130 the message processor of the message server processes the multilayered message. At 140 the message server distributes the multilayered processed message to the target recipients of the message. The multilayered message is distributed in such a way that a first recipient can see the first layer as well as the second layer of the multilayered message, while a second recipient can see only the second layer of the message.

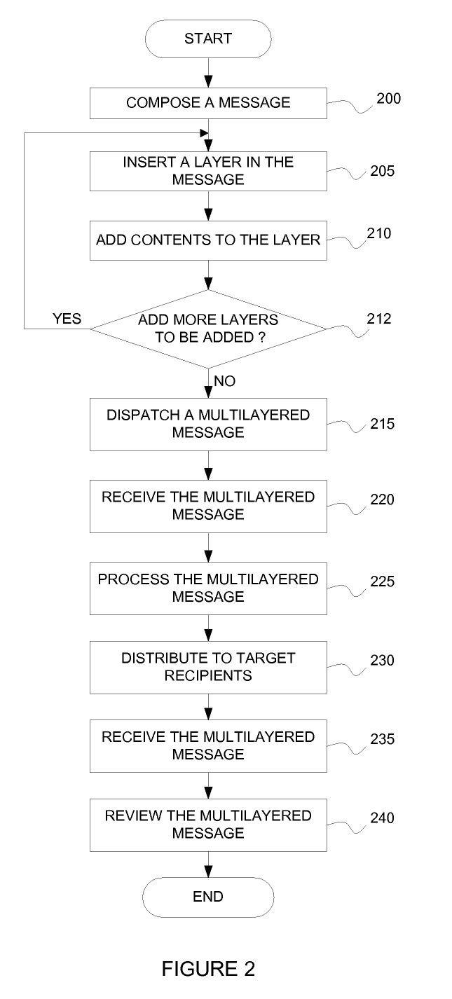

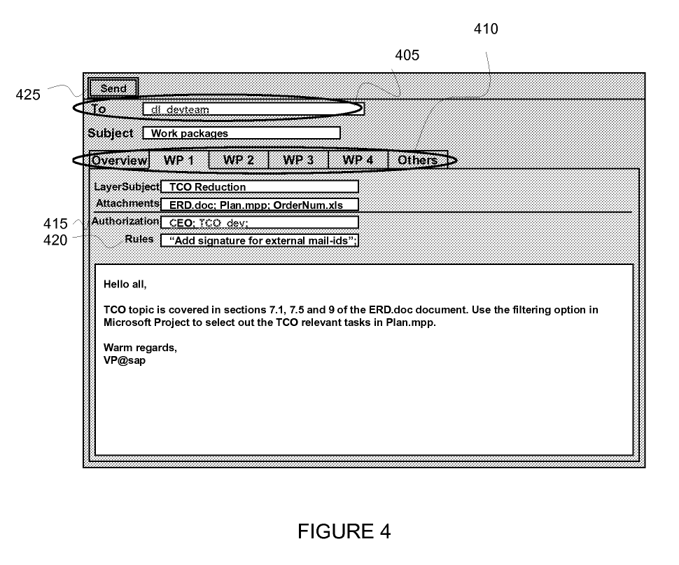

FIG. 2 is a flow diagram illustrating an example detailed method for providing a multilayered message, according to an embodiment of the invention. A multilayered message editor is used to compose the multilayered message at 200. The message editor supports inserting multiple layers to the multilayered message at 205. The multilayered message allows for adding message contents to the layers at 210. If more layers are to be added at 212 then repeat the step from 205 onwards. If at 212 there are no more layers to be added, at 215 then the message editor supports dispatching of the multilayered message to the message server. The multilayered message includes a first content in a first layer of the message, and a second content in a second layer of the message. There can be more than one second layer in a message, according to an embodiment as illustrated in FIG. 4. Examples of such contents are a message subject line, message attachments and objects such as documents, images, worksheets, media clips, voting buttons, etc. In another embodiment it is possible to have private formatting of the public content such as for example bold, highlight, underline or a different typeface and point size. The second recipient receives the second layer of the content and can then apply a different second formatting of the same content.

The message server receives a multilayered message at 220 and processes the multilayered message at 225. According to an embodiment of the invention, processing the multilayered message may include extraction of the layers and extraction of the associated metadata. The message server deciphers the metadata and the layers of the multilayered message. The processed multilayered message is distributed to a target recipient at 230. The target recipient receives the multilayered message at 235 along with any relevant first and a second layers. The multilayered message and any associated layers are displayed at 240.

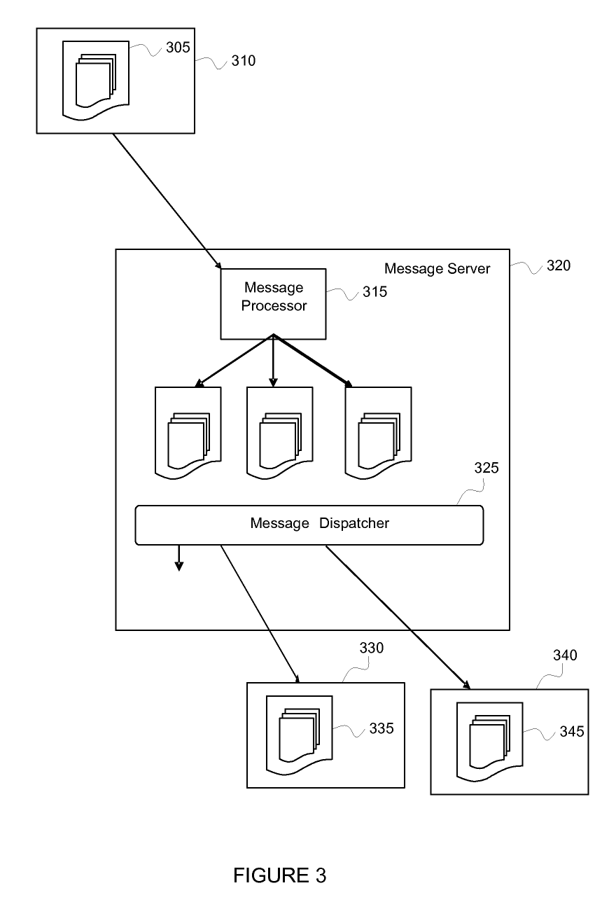

FIG. 3 is a system block diagram illustrating a multilayered message system implemented according to an embodiment of the invention. A multilayered message 305 contains multiple layers according to an embodiment of the invention. A multilayered message editor 310 allows for creation of the multiple layers within a single message and packages the multiple layers into a single multilayered message and dispatches the multilayered message to the message server 320. The message server 320 analyzes the metadata of each layer and processes the message accordingly and then the message server 320 sends the multilayered message to the target recipients. At the message server 320, the message processor 315 reads the metadata of each layer in the multilayered message and processes each layer based on the metadata associated with that layer. This processing includes accessing the user authorization, the user preferences and the settings. The message dispatcher 325 dispatches the multilayered message to the target recipients. In another embodiment, the message dispatcher 325 is communication coupled to the sender's message system. In another embodiment, the entire multilayered message is sent to a target recipient message system, where the target recipient message system processes and displays the multilayered message 335 using the recipient's graphical user interface 330

FIG. 4 is a screen display of an example graphical user interface illustrating the composition of a multilayered message. A recipient email address or alias or distribution list is entered using text field 405. A subject field 408 of the message is used to add a subject title to the multilayered message. A multilayered message has multiple layers, each layer being labeled as Overview, work package “WP1”, “WP2”, “WP3”, “WP4” 410. Each layer has a body 430 that contains information content specifically for that layer. Each layer has a layer subject 412 and attachments 413. Further, each layer has an associated layer metadata such as authorization 415 and rules 420. The ‘Send’ button 425 is used to dispatch the multilayered message to the target recipients 430.

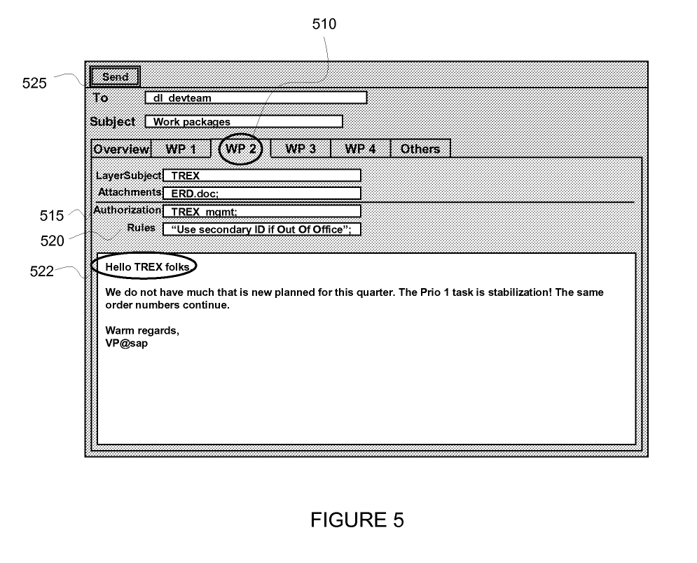

FIG. 5 is a screen display of an example graphical user interface illustrating the composition of a multilayered message. A sender composes the multilayered message for a target group 505 with the subject line 508. For example, a layer WP 2 510 of the multilayer message has a layer-subject 512, an attachment 513, associated authorizations 515 and rules 520. The sender composes a multilayered message for the “dl devteam” with the layer WP 2 510 for “TREX” team 522. The ‘Send’ button 525 is used to dispatch the multilayered message to the target recipients.

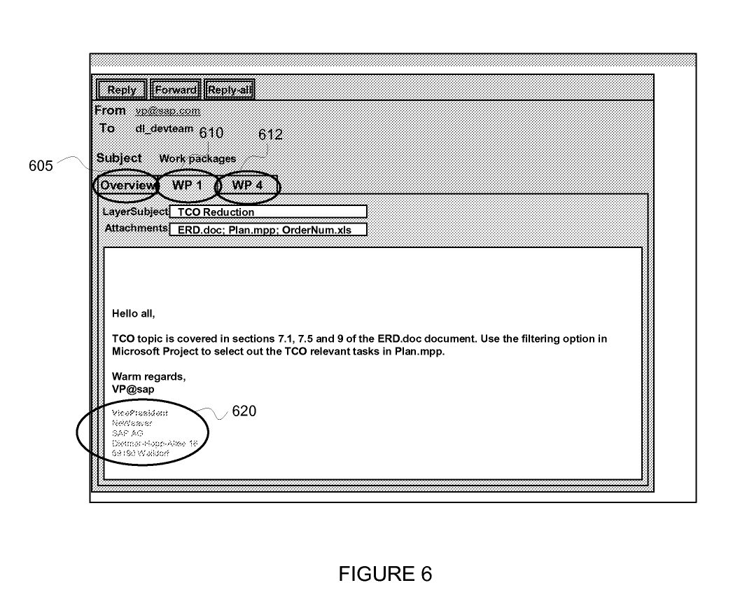

FIG. 6 is a screen display of an example graphical user interface illustrating displaying a multilayered message. The multilayered message is processed by the message server and dispatched to the recipient. The recipient receives only the relevant multilayered message from the sender in the recipient message system. As illustrated in FIG. 6, the recipient receives the layers of the multilayered message authorized for him. For example, the recipient's message has the public information under the “Overview” 605 while the private information is under WP1 610 and WP4 612. As the recipient is a member of the “TCO” team (WP1 610) and a member of the “BI” team (WP2 612). The received recipient message displays the sender's signature 620 as defined by the sender's rule.

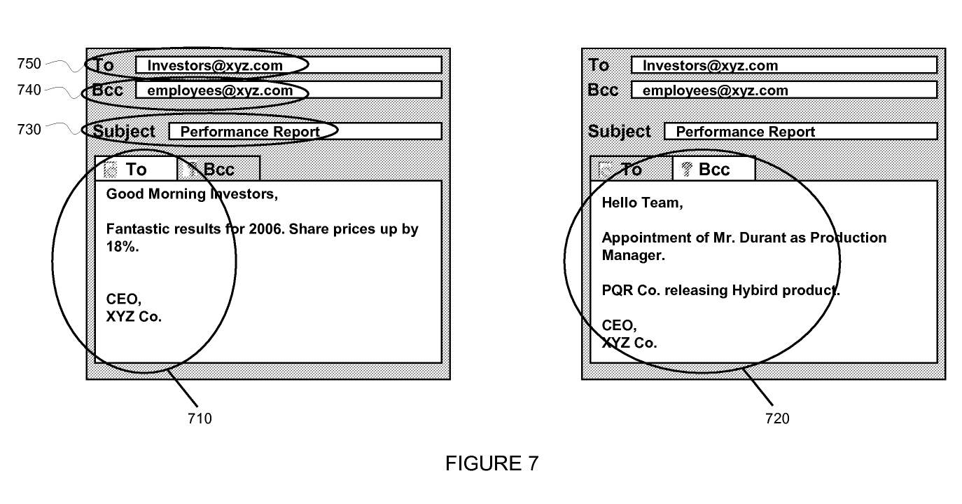

FIG. 7 is a screen display of an example graphical user interface illustrating the composition of a multilayered message. The figure illustrates the sender's message screen display having a several message layers for example a public message layer and private message layer. The public layer of the message 710 is the common information for the entire target recipient group, while the private layer “Bcc” 720 is only for private “Bcc” users. Thus illustrating a multilayered message having visibility control. The multilayered message is send by the CEO of XYZ Company announcing the performance report 730 to the employees 740 and with some restrictions to the investors 730.

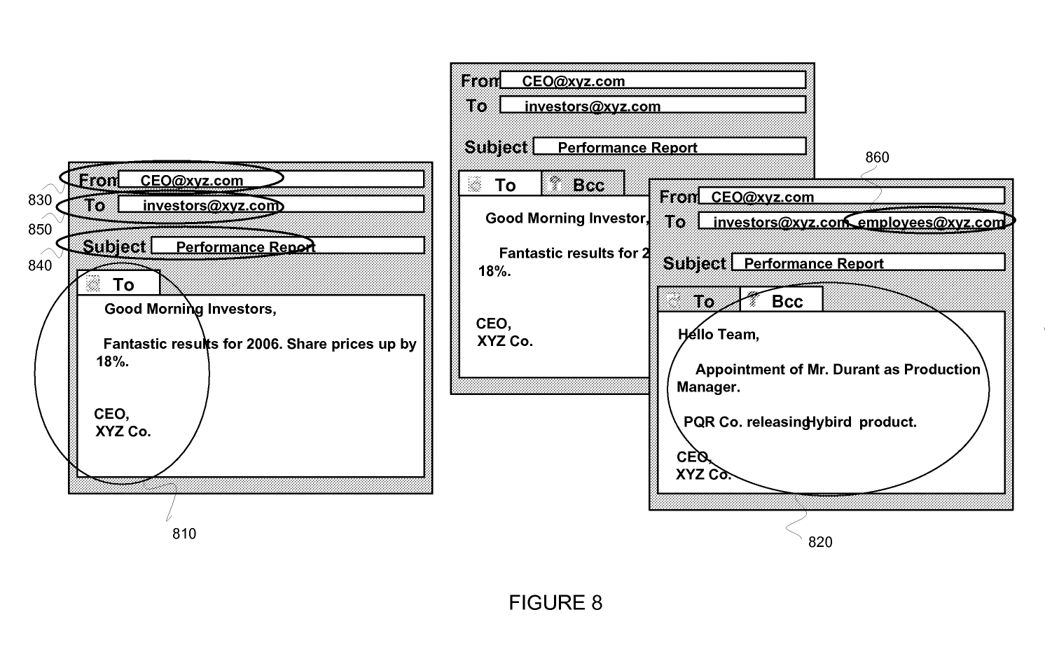

FIG. 8 is a screen display of an example graphical user interface displaying a message screen with both public and private layers. The figure illustrates the recipient's message screen along with both a public and a set of private layers. The public layer of the message is visible to every recipient of that message 810 while the private layer of the message that is the “Bcc” layer 820 is visible only to the private recipients. The multilayered message from the CEO of XYZ Company 830 announcing the performance report 840 to his employees and with certain visibility restrictions to the Investors. The investors 850 can see the contents under the “To” tab 810 and the employees 860 can see contents under both the “To” tab 810 and the “Bcc” tab 820 of the message.

What is claimed is:

1. A method, comprising:
providing a multilayered message;
dispatching the multilayered message to a message server;
processing the multilayered message at the message server; and
distributing the multilayered message to a target recipient.

2. The method of claim 1, the multilayered message further comprising:
inserting a layer in a message; and
adding contents to the layer of the message.

3. The method of claim 1, wherein each layer of the multilayered message further comprises a body of the message and an associated metadata.

4. The method of claim 1, the multilayered message further comprises a first layer and a second layer.

5. The method of claim 1, wherein processing the multilayered message comprises:
extracting the layers of the multilayered message; and
associating the metadata of the multilayered message with each message layer.

6. The method of claim 1, further comprises deciphering the metadata of the multilayered message.

7. The method of claim 1, further comprises handling the layers of the multilayered message based on the metadata associated with each layer.

8. The method of claim 1, wherein distributing the multilayered message to the target recipient comprising distributing the multilayered message based on the sender's defined rule.

9. The method of claim 1, further comprising reviewing the multilayered message by the recipient.

10. A system, comprising:
a message editor for providing a multilayered message and for dispatching the multilayered message;
a message processor of a message server for processing the multilayered message; and
a message dispatcher of the message server for dispatching the multilayered message to the target recipient.

11. The system of claim 10, further comprising using a multilayered message compliant editor for the multilayered message.

12. The system of claim 10, wherein the message processor comprises extracting the layers of the multilayered message and its associated metadata.

13. The system of claim 10, the message processor further comprising deciphering the metadata and handling each layer of the multilayered message based on the metadata associated with each layer.

14. The system of claim 10, wherein the message dispatcher coupled to a sender message system.

15. The system of claim 10, wherein the message dispatcher coupled to a recipient message system.

16. The system of claim 10, wherein the message dispatcher coupled to the message server.

17. An article of manufacture, comprising:
a machine readable medium having instructions that when executed by a machine cause the machine to execute a method, comprising:
providing a multilayered message;
dispatching the multilayered message to a message server;
processing the multilayered message at the message server; and
distributing the multilayered message to the desired recipient, after the processing.

18. The article of manufacture of claim 17, wherein each layer of the multilayered message further comprises a body of the message and an associated metadata.

19. The article of manufacture of claim 17, the multilayered message further comprises a first layer and a second layer.

20. The article of manufacture of claim 17, wherein processing the multilayered message comprises:
extracting the layers of the multilayered message; and
associating the metadata of the multilayered message with each message layer.
